(19) United States
(12) Patent Application Publication
(10) Pub. No.: US 2024/0161196 A1
(43) Pub. Date: May 16, 2024

(54) INVESTMENT LOSS AND PROFIT ALLOCATION METHOD AND SYSTEM BASED ON CONTRIBUTION RATIO OF LOWER NODES ON THE PROFIT

(71) Applicant: QUANTIT INC., Seoul (KR)

(72) Inventor: Duck Hee HAN, Seoul (KR)

(73) Assignee: QUANTIT INC., Seoul (KR)

(21) Appl. No.: 18/499,245

(22) Filed: Nov. 1, 2023

(30) Foreign Application Priority Data
Nov. 14, 2022 (KR) 10-2022-0151702

(51) Int. Cl. G06Q 40/06

(52) U.S. Cl. CPC G06Q 40/06

(57) ABSTRACT

The present invention allocates node variables to resources held by respective entities, which are servers or computer systems through a network, sets a connection to the resources required for generating an investment signal, and allocates the connection relationship as an edge variable. In addition, the present invention allocates a distribution rate for distributing loss and profit to each node as a value of the edge variable, so that the loss and profit to be distributed to each node during loss and profit distribution after investment execution can be easily derived from the value of the edge variable.

### CROSS-REFERENCE TO RELATED APPLICATION

This application claims priority to Korean Patent Application No. 10-2022-0151702 filed on Nov. 14, 2022, and all the benefits accruing therefrom under 35 U.S.C. § 119, the contents of which are incorporated by reference in their entirety.

### BACKGROUND

The present disclosure relates to an investment method and system for performing investment execution using a computer program, and more specifically, to a method and system for executing an investment using resources of various entities 10 and then distributing an investment loss and profit with the entities 10 that provided the resources.

A method of performing predetermined investment execution using a computer program and an investment execution system that performs the same are known. However, a method of performing the investment execution using the resources of other entities 10 in performing the investment execution and further efficiently distributing profits and losses resulting from the investment execution with other entities 10 is not known. For example, Patent document 1 below presents a method of constructing customized derivative products from real-time market data, client data, and performance metrics of other customized derivative products, but does not present a method of managing the use relationship of other derivative products. Patent document 2 only discloses a profit distribution method including a first step in which a server computer calculates investment income from an account linked to this strategy for an original strategy and a replication strategy and a second step in which the server computer distributes the investment income to the user and the third party users, but does not present specifically how to distribute the investment income.

### RELATED ART DOCUMENT

### Patent Document

Patent document 1: Korean unexamined patent application publication No. 2020-0106438 A
Patent document 2: Korean unexamined patent application publication No. 2014-0073968 A

### SUMMARY

Accordingly, a method of generating an investment signal for performing investment execution using data held by other entities 10 or a computer program or algorithm that generates data necessary for investment execution, managing a degree of contribution of the used data or algorithms of other entities 10, and managing a distribution rate for investment loss and profit according to the degree of contribution is needed. Furthermore, in distributing investment loss and profit with other entities 10, a method and system that can effectively manage/operate relationships with other entities 10 are needed. The present disclosure provides a method and system that solve such technical needs, effectively manages and uses the resources of other entities 10, which may be collectively referred to as data and computer programs of other entities 10, and further effectively distributes investment loss and profit for the utilization of the resources.

The present disclosure provides a method and system for allocating resources included in entities on a network as nodes, conducting investment execution using the resources included in each node, and distributing and loss and profit resulting from the investment execution between respective nodes.

In accordance with an exemplary embodiment, a method of distributing investment loss and profit to lower nodes, the method including: a node variable allocation step of allocating different node variables to one or more higher nodes that receive a lower resource and generate an investment signal for selecting a predetermined investment object or a resource for generating the investment signal, and one or more lower nodes that provide a resource to the higher nodes; a node network establishment step of specifying the resources for generating the investment signal and establishing connections with nodes holding the corresponding resource; an edge variable allocation step of allocating an edge variable to each of connection relationships with the lower nodes that provides the lower resource to the higher nodes; an investment execution step of generating the investment signal and conducting investment execution using the lower resource provided by the lower nodes; and an investment loss and profit distribution step of distributing the investment loss and profit according to an investment execution result according to a distribution rate set in the edge variable.

In the method of distributing investment loss and profit to lower nodes, in the distribution rate setting step, the highest node in the established node network may calculate a contribution rate of each of lower nodes when generating the investment signal using resources of the lower nodes, and calculate the distribution rate of investment loss and profit for each node based on the calculated contribution rate.

In the method of distributing investment loss and profit to lower nodes, the calculated distribution rate may be set in each edge variable indicating the connection relationship between the respective nodes, and a loss and profit dividend to each node may be calculated based on a product of the distribution rate set in the edge variable and the investment loss and profit.

In the method of distributing investment loss and profit to lower nodes, the lower resource request step may include a lower resource calling step of calling the lower node holding a predetermined lower resource and connecting a network with the lower node, and further include a resource request call variable increase step of increasing a resource request call variable when the higher node requests the lower resource according to the lower resource request step, and a resource provision call variable increase step of increasing a resource provision response variable when the lower node provides the lower resource according to the higher resource provision step.

In the method of distributing investment loss and profit to lower nodes, the investment loss and profit distribution step may further include a procedure of verifying whether or not the distribution rate between the higher node and the lower node is appropriate.

In accordance with another exemplary embodiment, a method of distributing investment loss and profit between network entities, the method including: a node setting step of allocating node variables to resources included in a plurality of network entities connected through a network; a resource list derivation step of deriving a list of resources required for generating an investment execution signal; a node network establishment step of establishing a connection relationship of nodes holding resources included in the resource list as a ‘connection’ attribute; an investment execution step of requesting and receiving resources from the nodes set as the connection attribute and performing investment execution; an edge variable setting step of calculating a distribution rate for distributing a loss and profit of investment execution to the nodes that provided the resources, and setting the calculated distribution rate in an edge variable expressing a connection relationship with the nodes that provided the resources; and a loss and profit distribution amount calculation step of collecting the set edge variables and calculating a loss and profit dividend to be distributed to each node based on a product of the loss and profit of investment execution and the edge variable.

In accordance with yet another exemplary embodiment, a loss and profit distribution system between network entities, the system including: two or more network entities on a network provided with resources used to generate an investment signal for investment execution, in which one of the entities is allocated as a highest node that generates the investment signal by utilizing the resources held by other entities, and a highest entity to which the highest node belongs is configured to include a node network module that allocates node variables to the resources held by the entities and sets nodes required for generating the investment signal as connection, and a loss and profit distribution module that distributes investment loss and profit resulting from the investment execution to the nodes set as connection, the node network module allocates an edge variable to a connection relationship between the nodes set as connection, and the loss and profit distribution module calculates a distribution rate based on resources provided from the nodes set as connection, allocates the distribution rate for distributing the loss and profit to each node to the edge variable, and calculates the loss and profit to be distributed to each node according to a value of the edge variable.

In the loss and profit distribution system between network entities, the highest entity may further include a resource acquisition module that identifies the resource required for generating the investment signal, queries each lower node to see if the resource is a resource that can be provided by each lower node, or reads a given resource database and generates a signal requesting provision of a lower resource to the lower node that can provide the lower resource, and acquires the resource from the lower node, and an investment execution module that generates the investment signal using the acquired resource of the lower node.

### BRIEF DESCRIPTION OF THE DRAWINGS

Exemplary embodiments can be understood in more detail from the following description taken in conjunction with the accompanying drawings, in which:

FIG. 1 is a diagram illustrating an example in which entities are connected through a network in accordance with an exemplary embodiment;

FIG. 2 is a diagram illustrating an example in which nodes are connected through a network in accordance with the exemplary embodiment;

FIG. 3 is a diagram illustrating an example in which each node is connected through a node network in accordance with the exemplary embodiment;

FIG. 4 is a block diagram illustrating a configuration of a highest node of the exemplary embodiment;

FIG. 5 is a flowchart illustrating a loss and profit distribution procedure in accordance with the exemplary embodiment; and

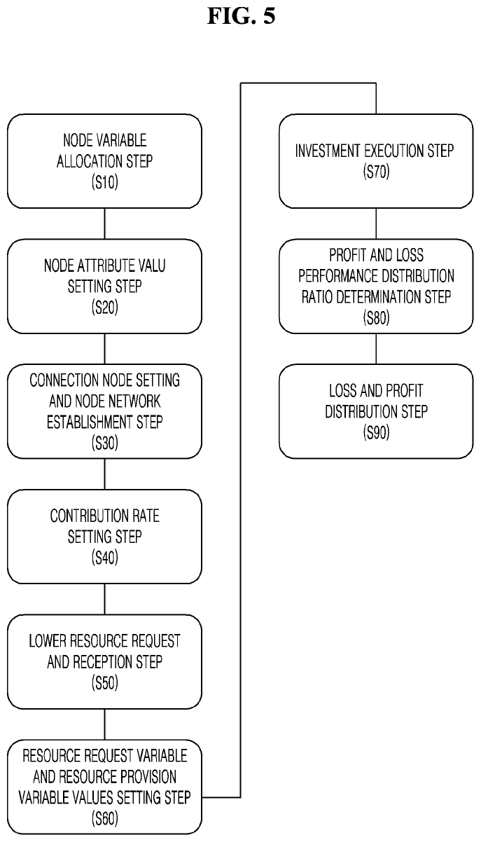

FIG. 6 is a diagram illustrating a case where, in an actual system, resources held by respective entities are set as nodes.

### DETAILED DESCRIPTION OF EMBODIMENTS

The present disclosure relates to a method and system for executing an investment by generating a signal for executing the investment by utilizing the resources of a number of different entities 10 and distributing profitability performance for investment execution with the number of different entities 10 who provided resources according to a predetermined distribution rate.

1. Description of Terms and Functions of Major Configurations

First, the meaning of the technical terms used in the present disclosure and the functions performed by the main configurations are described.

(1) Resource, Entity 10, Node

In the present disclosure, ‘resource’ refers to data used to generate an investment signal for selecting a predetermined investment object, a computer program/process that processes data for a predetermined purpose to create new data, and a computer program/process used to generate the investment signal.

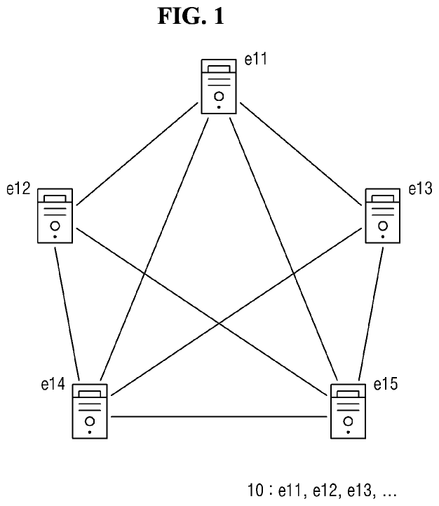

The ‘entity 10’ refers to a server or computer system that holds the resource. FIG. 1 is an example illustrating that predetermined entities are connected through a data communication network. Each entity may be a server/computer system that holds resources such as news data, macroeconomic variables, stocks, bonds, market indicators, and corporate financial indicators, and may be a server/computer system that holds a computer program/process that processes these data and calculates predetermined economic indicators. Further, the entity 10 may be a server/computer that provides a portfolio used to generate the investment signal using the resources of other entities, and may be a server/computer that generates the investment signal using the resources of other entities and performs final investment execution. Since these entities 10 are connected to a network, they are also called ‘network entities’.

As illustrated in FIG. 1, respective entities 10 (e11, e12, e13, . . . ) are connected through a data communication network, and the type of data communication network is not limited to the type of FIG. 1 or a specific network type. The data communication network complies with a structure of a normal data communication network, and respective entities can be connected through a dedicated line, the Internet, or a wired/wireless network.

‘Node’ is a unit of network configuration allocated to each of the resources, and when starting a process of the present disclosure, it is set as a node variable having each identification value by the highest node. One entity 10 may be assigned one node variable and set as one node, or each of multiple resources held by one entity 10 may be set as a node.

That is, in the present disclosure, ‘node 20’ refers to the ‘entity 10’ that holds and provides the resource, or, more specifically, to an algorithm module formed by individual data groups, computer programs/processes, or groups thereof included within the entity 10.

Each node may be included in the entity 10, which is configured to include one computer device or multiple computer devices, and a data storage device in which data is recorded, and a communication device, and if a node is set as a group of individual data, computer programs/processes or an algorithm module formed as a group thereof, two or more nodes may be set within one entity 10. That is, two or more nodes can be set within one computer system.

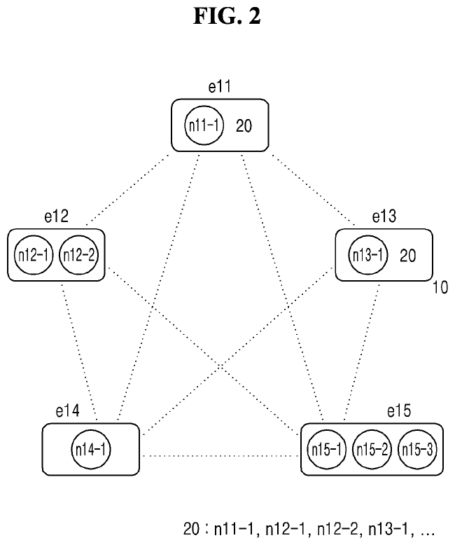

FIG. 2 illustrates an example of the node 20. FIG. 2 illustrates an example in which only one node n13-1 is set in entity e13, but two nodes n12-1 and n12-2 are set in entity e12, and three nodes are set in entity e15.

The investment execution and profit distribution system of the present disclosure is configured to include a node network in which two or more nodes are connected, and respective nodes are connected to each other through a data communication network to exchange a predetermined resource. A node network, which is a data communication network between respective nodes, is configured with a computer network that includes inter-process communication within one computer system and inter-process communication between a plurality of computer systems, and complies with the properties of an ad-hoc network in which the connection relationship between the nodes is set and reset at any time point under the control of the highest node.

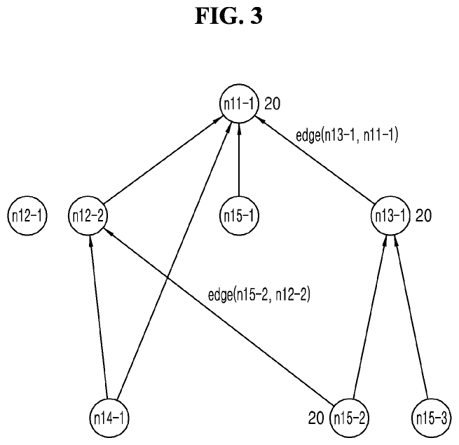

FIG. 3 illustrates an example in which the node network is established. In the drawing, the arrows on edges connecting the nodes do not mean one-way communication, but indicate the direction of providing resources. The example in FIG. 3 illustrates that n12-2, n15-1, and n13-1 are connected as lower nodes that respectively provide the resources to n11-1, and n12-2 and n13-1 are again connected as higher nodes of n14-1, n15-2, and n15-3 to receive resources.

(2) Higher Node/Lower Node

For nodes included in a computer network including two or more nodes of the present disclosure, an upper/lower relationship between the nodes may be relatively determined. In the present disclosure, a node that requests a predetermined resource from other nodes for generating an investment signal is referred to as a higher node, and a node that provides the resource in response to the request of the predetermined resource is referred to as a lower node. Except for the highest node and the lowest node, each node may become a higher node in relation to a specific lower node and function as a lower node for other nodes.

The lowest node refers to a node that only provides the resource to other nodes, and the highest node is a node that receives the resources from other nodes to perform investment execution and profit distribution. The highest node is described in more detail below.

Each node refers to predetermined data or a computer algorithm that generates other data using or predetermined data called a resource. If one higher node requests the resource from a lower node connected thereto, when responding to the request, the lower node generates requested data using its own computer algorithm and provides it to the higher node, or provides the computing power of its own computer algorithm to the higher node so that the higher node can use the algorithm. In this case, the lower node can request and utilize the resource held by other lower nodes when generating the requested data. The resource of each node is also referred to as a node resource.

(3) Node Variable/Node Attribute Value

One or more node attribute values may be allocated to each node variable, and as the node attribute value, a resource type attribute value showing whether the node resource held or provided by the node is data or a computer algorithm, a resource class attribute value, which is a value of the node resource provided to a higher module determined in advance, and the like may be allocated. Each node variable also has a unique identification value (id) in the node network of the corresponding node.

(4) Edge/Edge Variable/Edge Attribute Value

In the present disclosure, a connection relationship between the higher module and the lower module is set as ‘edge’, and the connection relationship of each node is set as one of the edge attribute values. For example, if the highest node and a specific node below it are connected as nodes that exchange resources, the edge variable between the highest node and the specific node may have a connection attribute value of ‘1’, and if not connected, the edge variable may be set to have ‘0’.

FIG. 3 illustrates an example in which the edge variable connecting node n11-1 and node n13-1 is set as edge (n13-1, n11-1). In this case, since node n11-1 and node 13-1 are connected to each other, the connection attribute value of the edge variable edge (n13-1, n11-1) is set to ‘1’, and since there is no connection between nodes n12-1 and n11-1, the connection attribute value of an edge variable edge (node n12-1, n11-1) is set to ‘0’.

As one of the attribute values of each edge variable, an identification value of the higher node and lower node connected to each other may be set as an identification attribute value of each edge variable, and a distribution rate that indicates the extent to which resources provided to the higher node contribute to the generation of resources generated by the higher node is allocated to each edge variable.

(5) Resource Request Variable/Resource Provision Variable

The resource request variables and resource provision variable may be allocated in association with each node. A type of resource requested from the lower node and the number of times the resource is requested are recorded in the resource request variable, and the type of resource provided to the higher node and the number of times the resource is requested are recorded in the resource provision variable, and the resource request variable and the the resource provision variable may be used as basis data for monitoring and verification of resource request and provision between the higher/lower nodes. Each node receives the resource provision variable and increases it when a resource is provided. The resource provision variable, along with its setting value, may be shared between the highest node and its lower nodes, and the lower node may verify the distribution rate allocated to the edge variable with the higher node by checking the resource provision variable.

(6) Highest Node

In the present disclosure, the highest node is a node that is a higher node of all nodes, performs final investment execution using the resources of one or more lower nodes, and distributes the investment profit to the lower nodes. The highest node is physically located on a server or computer system that receives the resources from the lower nodes and executes the final investment. In the example of FIG. 3, node n11-1 corresponds to the highest node.

The highest node includes a node network establishment module that establishes a node network with the lower nodes, a resource acquisition module that determines resources required for investment execution and requests the resources from the lower nodes, an investment execution module that conducts investment execution using a lower resource, and a profit distribution module that distributes the profits obtained as a result of the investment execution to the lower nodes. This means that the entity e11, in which the highest node is physically included, is configured to include the modules described above.

Each module is configured with a software module including a software algorithm that performs a predetermined function described below or a set thereof. The highest node, like other nodes, may be configured to include one computer device or multiple computer devices, and a data storage device in which data is recorded and a communication device.

\textcircled{1} Node Network Module 11

The node network module 11 sets the connection between respective nodes and controls data communication between the nodes. That is, the node network module 11 calls respective lower modules on the network and connects them to form the node network, and allocates the node variables, node attribute values, edge variables, and edge attribute values described above to the called lower modules. It is obvious to those skilled in the art that the formation of the node network can be performed according to a conventional computer network configuration technique and method.

In setting the node attribute values and edge attribute values, the node network module 11 can allocate attribute values through a procedure of receiving and verifying data of attribute values from respective lower nodes according to a data format agreed in advance with the respective lower nodes, and checking the data of attribute values. Alternatively, the node network module 11 may be provided with a database including data on respective nodes and the attribute values of the nodes set in advance, and read the database and allocate the attribute values when establishing the node network.

\textcircled{2} Resource Acquisition Module 12

The resource acquisition module 12 identifies the resources required for generating the investment signal, and queries each lower node whether it is a resource that can be provided by each lower node or reads a predetermined resource database and generates a signal requesting provision of the lower resource to the lower node that can provide the resource, and delivers the signal to the node network module 11.

The resource acquisition module 12 increases a value of the resource request variable when requesting the resource from the lower node. In addition, the resource acquisition module 12 delivers the resource provision variable to each lower node when requesting resources from the lower node, compares the resource provision variable value, which is increased by each lower node when providing the resource, with the resource request variable value, thereby capable of monitoring the resource request and resource reception. The resource provision variable value and the resource request variable value may be compared at the time of resource request and resource provision, or may be compared in total at the time of profit distribution for each node, which will be described later.

\textcircled{3} Investment Execution Module 13

The investment execution module 13 calculates the resources of the lower nodes required for generating an investment signal for investment execution, transmits a list of required resources to the resource acquisition module so that the resource acquisition module can acquire the resources of the lower nodes.

In addition, the investment execution module 13 generates the investment signal for investment execution and a signal combination of the investment signals based on the lower resource node resources received from the lower nodes through the resource acquisition module, and transmits them to an external system to conduct the investment execution. It is obvious to those skilled in the art that the generation of the investment signal for investment execution and the signal combination of the investment and investment execution using them can be implemented using a technology applied to investment execution models such as stocks and funds using ordinary computers. In this case, the resources utilized by the investment execution module 13 may include resources held by the entity 10 in which the highest node is included. That is, the highest node can connect the node included in the same entity 10 as a lower node.

The investment execution module 13 of the present disclosure is distinguished from a normal investment execution 13 in that it uses the resources of one or more lower nodes when generating the investment signal and gives a predetermined contribution rate (contribution rate is described in detail in item (8) below) to the used resource of each lower node. The predetermined contribution rate is set to a value promised to each lower node in advance, or is determined by reflecting the resource request variable value and a resource grade attribute value set in each node, and reflecting the product of the value of each lower node resource and the number of times each lower node resource is provided.

\textcircled{4} Loss and Profit Distribution Module 14

The loss and profit distribution module 14 distributes the investment loss and profit generated by a predetermined investment, which is performed by the investment signal generated by the investment execution module 13, with the lower nodes. The loss and profit distribution module 14 sets a distribution ratio, which is a distribution ratio (distribution ratio is described in detail in item (9) below), for each lower node that is connected, that is, has received resources, and allocates the set distribution ratio to an edge variable expressing the connection relationship with each lower node.

The loss and profit distribution module 14 allocates the distribution rate to the edge variable which is set for the connection between respective nodes, and finally calculates a distribution amount to be distributed to each node from the product of the value of each edge variable and the amount of investment profit.

(7) Resource and Request/Provision Procedure of Resource

The resource refers to data held by each node, processed data, and a computer algorithm that processes data to generate a predetermined result.

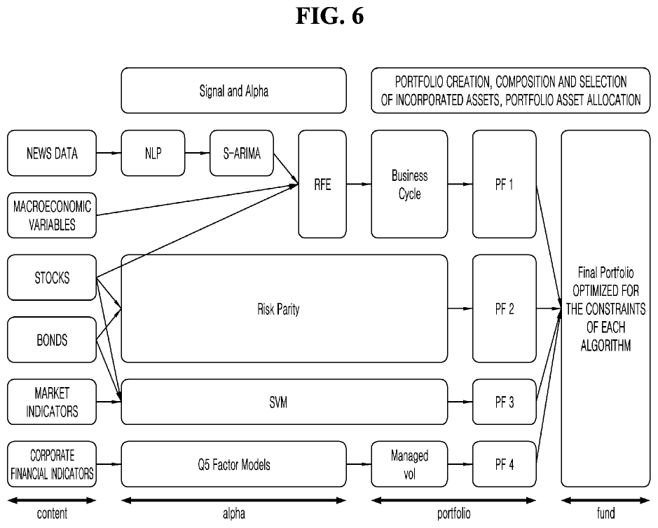

In the network composed of the nodes of the present disclosure, the lowest nodes hold data (contents). For example, FIG. 6 is a diagram illustrating a case where respective entities named content, alpha, portfolio, and fund, and the resources included in the respective entities are divided into nodes. The content, alpha, portfolio, and fund may be respectively constructed with one server or computer system, or may be configured with multiple servers or computer systems and exist on a network, and it is possible to set multiple nodes in each entity, or to set resources of each entity, such as risk parity and SVM nodes, as one node by linking the resources.

The lowest nodes illustrated in FIG. 6 are provided with news data, macroeconomic variable data, stock data, bond data, market indicator data, and corporate financial indicator data, respectively. These data resources may be provided as a database in one lowest node, several lowest nodes may be provided with several pieces of data, and one piece of data may be provided in each lowest node. Further, the data resources held by the lowest nodes may partially or fully overlap data resources held by other lowest nodes.

In the embodiment illustrated in FIG. 6, it is illustrated that the nodes of the alpha layer are provided with predetermined algorithms, that process data of the lower nodes, as resources.

For example, in the case of the node ‘Risk Party’, it owns an algorithm of the ‘Risk Party’ model that allocates a risk factor, requests stock and bond data, which are provided by the lower nodes, from the lower nodes and receives them as lower resources, and provides an output of the Risk Party to its higher node, ‘PF2’.

In FIG. 6, the highest node is ‘fund’, which forms the final investment portfolio by being provided from predetermined data from its lower nodes, PF1, PF2, PF3, and PF4. That is, in the example of FIG. 6, the highest node requests and receives resources from all of its lower nodes PF1, PF2, PF3, and PF4. For example, in providing the resources to the highest node, node PF2 uses the resources of its lower node, Risk Party, as described above and Risk Party again generates resources using stock and bond data, which are its lower nodes, and provides the resources to PF2.

The resources generated by the highest node using the resources of lower nodes becomes an investment execution signal.

In this way, in the present disclosure, each node holds its own resources, and respective nodes except the lowest node request and utilize the resources of their lower nodes in generating the resources.

(8) Contribution Rate

The contribution rate is a value for setting the value of each lower node resource when each node calls a lower node and requests and receives the resource of the lower node.

For example, when the highest node receives resources from its lower nodes PF1 to PF4, the value thereof can be set to approximately 25% each or set to uneven values. The sum of the contribution rates of respective lower nodes in the layer immediately below is set to approximately 100% or less, and a value obtained by subtracting the sum of the contribution rates of the lower nodes in the layer immediately below from 100 is set as the contribution rate of the corresponding higher node. That is, the total contribution rate of one higher node and the lower nodes in the layer immediately below (directly connected lower nodes, lower nodes connected through one edge) is set to be approximately 100%.

Here, the lower nodes in the layer immediately below refers to the lower nodes that are directly connected to one higher node without going through other nodes. Since the network of the respective nodes in the present disclosure can be established as an ad-hoc network, each node does not have a defined layer. Accordingly, in some cases, the lowest node in FIG. 2 may become a lower node of the layer immediately below the highest node by providing data directly to the highest node.

The contribution rate is determined for each lower node used by each node in generating predetermined resources, and can be reset at any time point by the node network module of the highest node. The reset time point may be, for example, approximately one hour before the market starts each day.

The contribution rate of each node can be determined as a whole by the highest node, or by each higher module when forming a network. The highest node or each higher module can set the contribution rate by reflecting the value attribute grade among the node attribute values set for each node in setting the contribution rate of the lower level module thereof.

Distribution Rate

Distribution rate is a ratio of distributing profitability performance to lower nodes. As for the distribution rate, like the contribution rate, a predetermined distribution rate may be assigned to each lower node by the profit distribution module of the highest node, or the distribution rate to the lower module may be determined by the higher module connected to the lower module.

The distribution rate is calculated based on the contribution rate, and the number of times the resources of each lower node are called can be reflected in the calculation of the distribution rate.

In addition, as for the distribution rate, a correlation between data input into the investment signal generated by the highest node for investment execution and lower node resource data received from the lower node is calculated and a value of the correlation can be utilized to set the distribution rate. In this case, there is an effect of accurately reflecting the degree of utilization of lower node resources used to generate investment signals in the distribution rate.

2. Method of Distributing Investment Profitability Performance to Lower Modules According to the Present Disclosure

The present invention execute investment using the resources of lower nodes and distributes the results of investment execution to the lower nodes according to the procedure below.

(1) Node Variable Allocation Step S10

In the present disclosure, the highest node is allocated to a computer server provided with the investment execution module 13 that generates an investment signal for a predetermined investment object. In executing an investment, the highest node connects the lower entities 10 through a network and generates an investment execution signal using the resources held by the lower entities 10.

To this end, the node network establishment module included in the highest node maintains a database of the list of entities 10 that hold connectable resources on the network, and performs a node variable allocation step that gives the node variable to the ‘entity 10’ that holds and provides the resources, or, more specifically, to an algorithm module formed by individual data groups, computer programs/processes, or groups thereof included within the entity 10.

One or more attribute variables related to the corresponding node can be allocated to the node variable, and node attribute values can be set to the corresponding attribute variables, respectively.

(2) Node Attribute Value Setting Step S20

This step is a step of allocating the node attribute values described above to respective node variables that are set. As described above, the node attribute values are given to the respective nodes while the node network module of the highest node establishes a network with other.

(3) Connection Node Setting and Node Network Establishment S30

The highest node establishes a node network by setting a connection relationship with the nodes given the node variable. Node network establishment is performed by the node network module 11, and the node network setting establishment is performed by setting edge variables that express the connection relationship between respective nodes and setting the connection attribute value of each edge variable.

In the node network establishment, if the investment execution module 13, which will be described later, generates and outputs a list of resources of lower nodes required for generating the investment signal, the node network module can receive the resource list signal and set a connection relationship with the corresponding lower node.

In another embodiment, according to the ad-hoc network establishment method, whenever the investment execution module 13 requests the lower node resources required for generating the investment signal, the node network module calls the lower node so that the lower node is connected, and sets the connection attribute value of the edge variable as connection.

The node network may be reestablished before the start of a daily market (for example, daily stock market) or updated from time to time. As the node network is reestablished or updated, the attribute value of each node variable, edge variable, and edge variable attribute values may be reset.

(4) Contribution Rate Setting Step S40

This step is a step in which the node network module 11 sets the contribution rate of each connected node by reflecting a value attribute grade of the node attribute value for each node connected to the stablished node network.

The contribution rate is determined for each lower node used by each node in generating predetermined resources, and may be reset at any time point by the node network module 11 of the highest node. The resetting time point may be, for example, approximately one hour before the market starts each day.

The contribution rate of each node can be determined as a whole by the highest node, or by each higher module when forming the network. The highest node or each higher module can set the contribution rate by reflecting the value attribute grade among the node attribute values set for each node in setting the contribution rate of the lower module thereof.

(5) Lower Resource Request and Reception Step S50

For the list of lower node resources collectively requested by the investment execution module 13 or a lower node resource request that frequently occurs, the node network module 11 sets a connection with the node holding the corresponding resource, and the resource acquisition module 12 requests and acquires the corresponding resource and provides the acquired resource to the investment execution module 13.

(6) Resource Request Variable and Resource Provision Variable Values Setting Step S60

This is a step in which the resource request variable value is increased when a lower resource is requested from the lower node, and the resource provision variable value is increased when the resource is provided. The procedures for setting the resource request variable and the resource provision variable and increasing their values are the same as described above.

(7) Investment Execution Step S70

This step is a step in which the investment execution module 13 conducts investment execution using the provided lower resources. Since a method of generating a predetermined investment signal and executing an investment using predetermined data, a predetermined computer program/process, a server or a computer system, that is, a method of financial investment for stocks, funds, etc. using a computer program is known as a known technology, detailed description thereof is omitted in the present disclosure.

(8) Loss and Profit Distribution Rate Determination Step S80

This step is a step in which the loss and profit distribution module 14 sets a distribution rate and allocates it to an edge variable in distributing the investment loss and profit, which are generated by a predetermined investment performed by the investment signal generated by the investment execution module 13, with the lower nodes.

In this case, the distribution rate can be determined by reflecting the contribution rate, the resource request variable value, and the resource provision variable value of connected lower nodes, and the contribution rate for the distribution rate of the node that does not provide the resource can be set to 0. For example, the distribution rate can be determined based on the contribution rate of the connected node. For example, if there are two lower nodes that are connected and use the resources, the distribution rate can be determined according to the contribution rate set for each node. For example, if the contribution rate of lower node A is determined to be approximately 30% and the contribution rate of lower node B is determined to be approximately 20%, the distribution ratio between lower node A, lower node B, and a higher node is determined to be approximately 30:20:50, respectively.

In another embodiment, the distribution rate can be allocated by reflecting the number of times the lower resource is called. During the network establishment period (until the next day market begins and the node network is reestablished), if i is the total number of times a higher resource calls a lower resource, and j is the number of times the lower node responds to a call, the distribution rate of the corresponding lower node can be determined by multiplying the contribution rate of the corresponding lower node by a response rate per call j/i. In this case, the contribution rate of the lower node reflects the promised value of the lower node resource, and (the number of times of responses/the number of times of calls) reflects an actual execution rate of the lower node resource.

In addition, as for the distribution rate, a correlation between data input into the investment signal generated by the highest node for investment execution and lower node resource data received from the lower node is calculated and a value of the correlation can be utilized to set the distribution rate. In this case, there is an effect of accurately reflecting the degree of utilization of lower node resources used to generate investment signals in the distribution rate.

This distribution rate can be allocated as the edge variable value connecting each node when forming the node network, and the edge variable value can be updated according to the reestablishment or update of the node network, or after being calculated by reflecting the contribution rate, the number of times the lower resource is called, and the like described above.

(9) Loss and Profit Distribution Step S90

This step is a step of distributing loss and profit to each node based on the determined distribution rate. Since the determined loss and profit distribution rate is recorded in the edge variable, which is a variable of the connection relationship between respective nodes, in the loss and profit distribution step, the edge variable value of each node is read and the loss and profit are distributed according to that ratio.

In this way, according to the procedure of the present disclosure the loss and profit distribution is made very effectively and efficiently for each node that provided the resource. Furthermore, the present disclosure may include a procedure for verifying the set distribution rate before or after the loss and profit distribution step. In the present invention, since the lower nodes share the resource provision variable value, the lower nodes can monitor the value of resource provision variable and introduce a process of comparing the value of resource provision variable with the actual number of resource provision times to perform a process of inquiring and verifying whether or not the set distribution rate is appropriate, and the present invention may include, in the loss and profit distribution step, a procedure of verifying whether or not the determined edge variable value is appropriate based on the resource provision variable.

3. Investment Execution and Loss and Profit Distribution System According to the Present Disclosure

The investment execution and loss and profit distribution system according to the present disclosure has the following detailed configurations. Since the main configurations have been described previously, an overall structure of the system according to the present disclosure will be described here with reference to FIGS. 1 to 4.

(1) Entity 10 and Node

The investment execution and loss and profit distribution system of the present disclosure is configured to include two or more entities 10 and nodes 20. The entity 10 and the node 20 are the same as described above with reference to FIGS. 1 and 2.

(2) Node Network

The ‘node network’ established in the present disclosure is not the same as the physical data communication network between the entities 10 related to FIG. 1 described above. The node network is a virtual network that sets a connection relationship between nodes that request and provide resources that the nodes hold to each other, or a network that connects flow paths of resources. Even if the physical data communication network is connected between the entities to which the nodes belong, the nodes may be set as not connected in the node network. For example, referring to the example of the node network establishment in FIG. 3, the case where the entity e12, in which a node n12-1 is included, is connected to a data communication network with other entities, but the n12-1 node does not provide the resource to other nodes, that is, the n12-1 node is not connected to the node network is indicated. In this case, it can be seen that a node n12-2 within the same entity is set as connected to the node network as a lower node of n11-1 and as a higher node of nodes n14-1 and n15-2.

(3) Highest Node

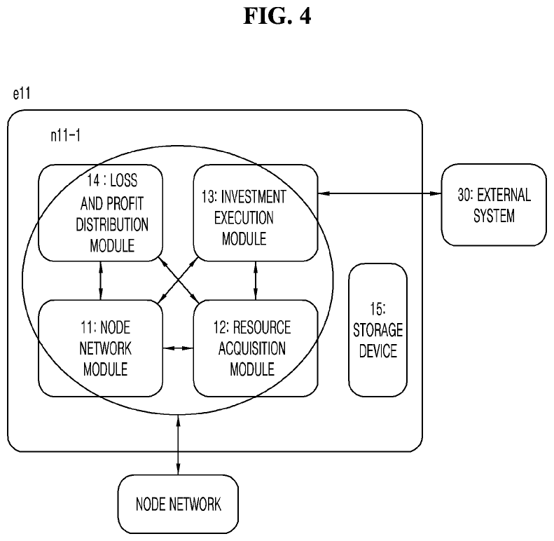

The system of the present invention includes the entity that constitutes the highest node described above. In the example of FIG. 3, the highest node corresponds to n11-1, and the highest entity 10 (e11) including the highest node is configured to include the node network module 11, the resource acquisition module 12, the investment execution module 13, and the loss and profit distribution module 14, as described above. A block diagram of the entity e11 to which the highest node belongs is illustrated in FIG. 4.

The highest entity 10 (e11) including the highest node may additionally include a storage device 15. The memory device 15 contains data on network addresses of each entity 10 and the types/attribute of the resource held by each entity 10, and the node network module 11 may allocate nodes to the resources included in the entities 10 when establishing the node network, and may call a node holding the corresponding resource or connect to the corresponding node when the investment execution module 13 specifies a resource required for generating the investment signal. As described above, the highest node generates the investment signal using the resources of the lower nodes and transmits it to an external system 30 to execute the investment, aggregates losses and profits resulting from the investment execution, and distributes loss and profit according to the distribution rate set in the edge variable of each lower node.

According to the present invention, when conducting investment execution using resources held by other entities 10, by providing a method of measuring the use of resources of other entities 10 and the degree of contribution of those resources to the investment profit or loss, an effect of effectively managing the distribution of investment loss and profit according to the use of resources of other entities 10 is achieved.

Although the investment loss and profit allocation method and system based on contribution ratio of lower nodes on the profit have been described with reference to the specific embodiments, they are not limited thereto. Therefore, it will be readily understood by those skilled in the art that various modifications and changes can be made thereto without departing from the spirit and scope of the present invention defined by the appended claims.

### REFERENCE SIGNS LIST

10(e11, e12, e13, . . . ) network entities
11 node network module
12 resource acquisition module
13 investment execution module
14 loss and profit distribution module
15 storage device
20(n11-1, n12-1, n12-2, n13-1, . . . ) nodes
30 external system
40 storage device

What is claimed is:

1. A method of distributing investment loss and profit to lower nodes, the method comprising:
a node variable allocation step of allocating different node variables to one or more higher nodes that receive a lower resource and generate an investment signal for selecting a predetermined investment object or a resource for generating the investment signal, and one or more lower nodes that provide a resource to the higher nodes;
a node network establishment step of specifying the resources for generating the investment signal and establishing connections with nodes holding the corresponding resource;
an edge variable allocation step of allocating an edge variable to each of connection relationships with the lower nodes that provides the lower resource to the higher nodes;
an investment execution step of generating the investment signal and conducting investment execution using the lower resource provided by the lower nodes; and
an investment loss and profit distribution step of distributing the investment loss and profit according to an investment execution result according to a distribution rate set in the edge variable.

2. The method of claim 1, wherein
the highest node in the established node network calculates a contribution rate of each of lower nodes when generating the investment signal using resources of the lower nodes, and
the distribution rate of investment loss and profit for each node is calculated based on the calculated contribution rate.

3. The method of claim 2, wherein
the calculated distribution rate is set in each edge variable indicating the connection relationship between the respective nodes, and
a loss and profit dividend to each node is calculated based on a product of the distribution rate set in the edge variable and the investment loss and profit.

4. The method of claim 3,
Further comprises
a resource request variable increase step of increasing a resource request call variable when the higher node requests the lower resource according to the lower resource request step, and
a resource provision variable increase step of increasing a resource provision response variable when the lower node provides the lower resource according to the higher resource provision step.

5. The method of claim 4, wherein
the investment loss and profit distribution step further comprises a procedure of verifying whether or not the distribution rate between the higher node and the lower node is appropriate.

6. A method of distributing investment loss and profit between network entities, the method comprising:
a node setting step of allocating node variables to resources included in a plurality of network entities connected through a network;
a resource list derivation step of deriving a list of resources required for generating an investment execution signal;
a node network establishment step of establishing a connection relationship of nodes holding resources included in the resource list as a ‘connection’ attribute;
an investment execution step of requesting and receiving resources from the nodes set as the connection attribute and performing investment execution;
an edge variable setting step of calculating a distribution rate for distributing a loss and profit of investment execution to the nodes that provided the resources, and setting the calculated distribution rate in an edge variable expressing a connection relationship with the nodes that provided the resources; and
a loss and profit distribution amount calculation step of collecting the set edge variables and calculating a loss and profit dividend to be distributed to each node based on a product of the loss and profit of investment execution and the edge variable.

7. A loss and profit distribution system between network entities, the system comprising:
two or more network entities on a network provided with resources used to generate an investment signal for investment execution, wherein
one of the entities is allocated as a highest node that generates the investment signal by utilizing the resources held by other entities,
a highest entity to which the highest node belongs is configured to include
a node network module that allocates node variables to the resources held by the entities and sets nodes required for generating the investment signal as connection, and
a loss and profit distribution module that distributes investment loss and profit resulting from the investment execution to the nodes set as connection,
the node network module
allocates an edge variable to a connection relationship between the nodes set as connection, and
the loss and profit distribution module
calculates a distribution rate based on resources provided from the nodes set as connection,
allocates the distribution rate for distributing the loss and profit to each node to the edge variable, and
calculates the loss and profit to be distributed to each node according to a value of the edge variable.

8. The system of claim 7, wherein
the highest entity further comprises
a resource acquisition module that
identifies the resource required for generating the investment signal,
queries each lower node to see if the resource is a resource that is providable by each lower node, or reads a given resource database and generates a signal requesting provision of a lower resource to the lower node capable of providing the lower resource, and
acquires the resource from the lower node, and
an investment execution module that generates the investment signal using the acquired resource of the lower node.
